(19) United States
(12) Patent Application Publication
(10) Pub. No.: US 2015/0018064 A1
(43) Pub. Date: Jan. 15, 2015

(54) System and Method for Machine Play of Open Face Chinese Poker

(71) Applicants: Louis Joel Mick, San Diego, CA (US); Kevin Martin Keller, San Diego, CA (US)

(72) Inventors: Louis Joel Mick, San Diego, CA (US); Kevin Martin Keller, San Diego, CA (US)

(21) Appl. No.: 14/327,538

(22) Filed: Jul. 9, 2014

Related U.S. Application Data
(60) Provisional application No. 61/844,357, filed on Jul. 9, 2013.

(51) Int. Cl. G07F 17/32

(52) U.S. Cl. CPC G07F 17/32
USPC 463/13

(57) ABSTRACT

An apparatus and method for OFCP machine play. The apparatus includes a non-transitory tangible machine-readable storage medium on which is stored a set of instructions. Execution by the processor of the instructions on the storage medium or media cause the apparatus to send data configured to create graphic display of a game of Open Face Chinese Poker. The stored set of instructions includes a game rule set, and the game rule set includes well known rules for the game and also at least one rule variation for the game that is selected from the following rule variations: a time limits/forfeits rule, a simultaneous showdown rule, an asymmetric game scoring and royalty modifications rule, a face down play rule, an exchange cards rule, a surrender rule, an identity coded computer play history rule, a no foul rule, a trash hand rule, a multiple instances rule, a computer co-play rule and a solitaire rule.

Execution by the processor of the instructions on the storage medium or media further cause the apparatus to receive and store an input from a human player, to determine, using the game rule set and the input from the human player, a next game play, and to send data configured to create a graphic display of the determined next game play.

### CROSS REFERENCE TO RELATED APPLICATIONS

This application claims priority to U.S. Provisional Patent application 61/844,357 filed Jul. 9, 2013 which is hereby incorporated by this reference as if fully set forth herein.

### TECHNICAL FIELD

This disclosure relates to machine based game play, and more particularly to machine play of games of chance such as card games, and to methods for playing card games and methods and apparatus for machine play of card games, in particular various forms of poker and more particularly Open Face Chinese Poker (OFCP).

### BACKGROUND

Many forms of well known games of chance have been adapted for machine play. Such games include Black Jack and Poker and OFCP; typical machines used to play such games include casino machines (such as slots) and various portable digital devices such as tablets and phones. Card games in general and machine play card games in particular are generally played by well-known conventional rules, and sometimes with the addition of lesser-known, or at least lesser-used, variant rules.

There are many forms of poker such as Five Card Draw, Five Card Stud, Seven Card Stud, and Texas Hold'em. The differences between these games relate to the way the cards are dealt and played and the way bets are placed. In a variant called Chinese Poker, each player receives a 13 card hand from a standard 52 card deck. In every game each player must divide those cards into three hands: a “front hand” containing a three card poker hand, a “middle hand” containing a five card poker hand, and a “back hand” containing a five card poker hand. The “back hand” (the one closest to the player) must be the highest ranking hand, and the “front hand” must be the lowest ranking hand. After each player has received and arranged the cards into three hands, corresponding hands are compared and scored. There is also an open-face variation to Chinese poker.

An excellent discussion of conventional OFCP and of machine play for conventional OFCP is contained in U.S. Pat. No. 8,727,852 issued to Palihapitiya et al on May 20, 2014, the entire text and drawings of which are incorporated herein by this reference as if fully set forth herein.

Another helpful review and discussion of card games, wagering, and machine play of card games with wagering schema is contained in US Patent Application 2014/0018137 by Flaherty published Jan. 16, 2014, the entire text and drawings of which are incorporated herein by this reference as if fully set forth herein.

### Conventional OFCP Basic Rules

The card game of Open Face Chinese Poker can be played with 2, 3, or 4 players. It uses a standard 52-card deck of playing cards. It is scored using a points system, where players win points from each other based on the outcome of each round of the game.

In each round of Open-Face Chinese Poker, each player receives 13 cards and needs to arrange these cards into 3 different poker hands. The hand closest to each player at the bottom of the 3 poker hands (the “Back” hand) must be a 5 card poker hand and should be the strongest of the player's 3 hands. The hand in the middle must also be a 5 card poker hand and should be weaker than the player's Back hand. The hand furthest away from each player at the top (the “Front” hand) must be a 3-card poker hand and should be the weakest of the 3 hands.

The ranking for the 5 card hands is the same as for regular poker. Namely the ranks from lowest to highest are: High card, Pair, 2 Pair, 3 of a kind, Straight, Flush, Full House, Straight Flush, Royal Flush. The ranking for the 3 card hand from lowest to highest is simply: High Card, Pair, 3 of a kind. In other words with the 3 card hand straights and flushes do not improve the rank of the hand and the best hand is therefore three aces (AAA).

Ordering the three hands correctly in descending strength (Back hand strongest to Front hand weakest) is a crucial part of the game. If a player fails to do so, that player is said to have “fouled”, and he loses all 3 hands against any opponent who did not foul. Furthermore, a player who has fouled is not entitled to any of the royalty bonuses described below.

In each round, one of the players possesses the “Dealer” button. After the cards have been shuffled, each player, starting with the player to the left of the player with the Dealer button and proceeding in a clockwise order, is dealt 5 cards face down (1 at a time, not 5 at a time). Each player, again starting with the player to the left of the player with the Dealer button and proceeding clockwise, then picks up his 5 cards and arranges them face up on the table, making it clear which cards he is allocating to his Back, Middle, and Front hands.

After all players have played their initial 5 cards, each player, starting with the player to the left of the player with the Dealer button and proceeding clockwise, then receives one card face down and plays it face up on the table in either his Back, Middle, or Front hand. This is repeated until each player has been dealt and has played an additional 8 cards.

Once a player has played a card in one of his 3 hands, the card cannot be moved to a different hand.

### Scoring Points in Open-Faced Chinese Poker

After all players have played a total of 13 cards, the play for the round is complete and the round is then scored. The scoring in Open Face Chinese Poker is based partly on winning one or more of the 3 hands, and partly on a Royalty bonus system for playing certain types of strong hands.

When played with only 2 players, the players compare hands with each other to determine which player has won each of the 3 hands. Each player wins 1 point from his opponent for beating his opponent's corresponding hand (e.g. Back hand vs. Back hand), and wins an additional 3 point bonus from his opponent for winning all 3 hands, which is referred to as “scooping” or “sweeping.”. So if a player wins 2 hands and loses 1 hand, that player gains a net of 1 point and his opponent loses a net of 1 point. But if a player wins all 3 hands (or loses all 3) then that player's net gain (or loss) is 6 points.

In addition to the scoring for winning or losing each hand, each player wins a specified amount of royalty bonus points from his opponent for each of his 3 hands that meets certain hand strength rules. Both players are eligible to win royalty bonus points from each other, regardless of who won each of the 3 hands. However, a player who has fouled his hand does not win any royalty bonus point, but can still lose royalty bonus points to his non-fouling opponent based on his opponent's hands.

If more than 2 players are playing, each player scores independently against each other player in the manner described above.

After the round has been scored, the Dealer button is moved one player to the left, the cards are collected and shuffled, and the next round is begun.

Royalty bonus points for Back hands are:

25 for a Royal Flush

15 for a Straight Flush

8 for 4-Of-A-Kind

6 for a Full House

4 for a Flush

2 for a Straight

Royalty bonus points for Middle hands are double the royalty bonus points listed above for the Back hand. Additionally, 3-Of-A-Kind in the Middle hand wins 2 royalty bonus points.

Royalty bonus points for Front (3-card) hands are:

3 Aces: 22 points

3 Kings: 21 points

. . . (et seq)

3 Threes: 11 points

3 Deuces: 10 points

Pair of Aces: 9 points

Pair of Kings: 8 points

Pair of Queens: 7 points

Pair of Jacks: 6 points

Pair of Tens: 5 points

Pair of Nines: 4 points

Pair of Eights: 3 points

Pair of Sevens: 2 points

Paid of Sixes: 1 point

### Fantasyland Rule Modification (a Sometime Optional Rule)

If a player plays a pair of Queens or higher as his Front hand without fouling, he goes to “Fantasyland” for the next round. While in Fantasyland, a player is dealt all 13 of his cards face down at the start of the round. He looks at all his cards and plays them face down creating a 3-card Front hand, a 5-card Middle hand, and a 5-card Back hand. Play then proceeds normally for all players not in Fantasyland. After the round is scored, a player who was in Fantasyland remains there for the next round if he plays 4-Of-A-Kind or better in his Back hand, a Full House or better in his Middle hand, or 3-Of-A-Kind in his front hand without fouling; otherwise he leaves Fantasyland and reverts to playing normally the next round. Note that more than one player may be in Fantasyland during the same round.

### Royalty Bonus Rules Modifications (Additional Optional Rules)

The iPad/iPhone application Chinese Open Face Poker permits players to change the number of points for, or to completely eliminate, royalties for the various Front, Middle and Back hands.

### DISCLOSURE

To set up an optimum gaming system for machine play of OFCP, one or more of the following new game rule modifications is made to conventional OFCP rules. It is believed that each of the disclosed rule modifications contributes to game enhancement through increase in speed of play, additional scoring options, closer management of risk of player loss per round (including setting the maximum loss per game) for one or more of the players, and possibility of increased levels of winnings for one or more of the players.

### New OFCP Rule Modifications

1. Time Limits/Forfeits Rule. Each player is given a limited amount of time to make each play. If a play is not made within the allotted time, (a) the cards are played randomly by the machine according to pre-programmed instructions; (b) the cards are played following some other pre-programmed rule; c) the player forfeits the current game and is scored as if he has fouled; or (d) the player is treated as if he has surrendered, as described in the surrender rule modification (8) below.

2a. Alternate Deal/Discard Rule. Rather than being dealt an initial set of 5 cards, and then 8 additional cards one at a time, resulting in a total of 9 separate card arrangement decisions for each player in each game, the cards are instead dealt in a series of less than 9 sets or card groups, and each player plays (places) all cards from each dealt set at the same time as the other players make their plays from their corresponding card sets dealt to them. For example, cards are dealt to all and played by all in a group of 5, followed by a group of 3, followed by another group of 3, followed by a final group of 2.

2b. As in rule modification 2a, except that some or all groups of cards dealt to the players contain more cards than the player is permitted to play, and each player decision includes the selection of which subset of less than all dealt cards to play in addition to the decision of which hand(s) to play the card(s) into. For example, for the initial placement of 5 cards, each player is dealt a set of 6 cards, and from that 6 chooses 5 of them to play and discards the unused card.

2c. As in rule modification 2b, except that instead of discarding unused card(s), the next group of cards dealt to each player is added to that player's unused card(s) from previous groups, so that the player may then play either his newly dealt card(s) or his unused card(s) from previous groups, or a combination of both.

3a. Simultaneous Showdown Rule. Instead of multiple players alternating turns, the “dealer button” is eliminated, and instead players take their turns simultaneously. For example, all players are dealt an initial 5 cards and choose where to place each card in their front, middle or back hands, without the other player(s) seeing how many or which cards are played in which hands until after all players have made their choices for their initial 5 cards. For instance, the hands can be arranged with cards held in the hand of a player, and then when all indicate readiness, a simultaneous show down of the arranged hands with no modification of course being permitted after the show down.

3b. Alternately to rule modification 3a, the Dealer button is eliminated and instead players always take turns in the same order, with the same player always playing his cards before all of the other players, the same player playing second, etc.

4a. Asymmetric Game Scoring and Royalty Modifications Rule. The game scoring and royalty bonus amounts are modified for at least one, but fewer than all, players. (Current art only modifies these amounts symmetrically for all players.) For example, so that one specific player has a more limited maximum loss per round, only the specific player elects never to have to pay out royalties to his opponents so that he can never lose more than 6 points per round to each opponent, but in exchange that player only receives one additional point for winning all 3 hands instead of the customary three points (while that player's opponents continue to receive a 3 point bonus for winning all 3 hands).

4b. Additional royalty bonus amounts are added. For example, a player also receives a 10 point bonus for making a hand ten-high or lower in his Back hand.

5a. Alternate Hand Count Rule. The total number of hands each player creates is changed. For example, each player is dealt a total of 8 cards and uses them to create one 3-card front hand and one 5-card back hand.

5b. In addition or alternately to rule modification 5a, the total number of cards held in one or more of each player's final hands is changed. For example, each player is dealt a total of 12 cards and uses them to create a 3-card front hand, a 4-card middle hand, and a 5-card back hand.

6a. Face Down Play Rule. When placing some or all of the cards in the current dealt set, players play cards face down so that they remain unknown to the other players until some selectable or pre-programmed later point in the game, or alternately until the end of the game when the scores are all calculated.

6b. When rule modification 6a is in effect, one or more players are given the option to pay some amount of points in order to immediately reveal some or all of the cards that one or more of their opponents played face down.

7a. Exchange Cards Rule. One or more players is permitted to pay some amount of points immediately after drawing (being dealt a set of cards) a selected one or more of the card sets in order to be permitted to exchange one or more cards from the selected set(s) for new cards drawn at random from the deck.

7b. Alternately or in additional to rule modification 7a, after being dealt a set of cards, players who so elect may choose to pay some number of points to exchange some or all of that set of cards with a like number of cards held by one or another of the other players. For example, if one human player is playing against one computer opponent, the human player may choose to pay 3 points to exchange his first set of 5 cards with those dealt to the computer opponent (with, or alternately without, knowing the identity of the cards to be received from the exchange). Thereafter play continues normally.

7c. Alternately to rule modification 7b, after being dealt a set of cards, players who so elect may choose to pay some number of points to exchange some or all of that set of cards with a like number of cards held in total by a combination of other players. For example, if one human player is playing against two human opponents, the human player may choose to pay 2 points to exchange two of his first set of 5 cards with two of his opponents, one card each with and from each opponent.

8. Surrender Rule. After being dealt a specified set of cards (for example, the first set dealt), one or more players may each choose to pay some number of points to surrender their game by folding their hand and no longer participating in being dealt further cards or in the final scoring of the game. The surrender points are paid by the surrendering player to each non-surrendering other player in the game, or optionally to the House. Alternatively, players may surrender at later points in the game (subsequent draws or cards dealt) for higher surrender cost.

9a. Alternate Deck Rule. Cards are dealt from a deck other than the traditional 52-card playing card deck. For example, cards are dealt from a stripped deck consisting only of the 36 cards in a traditional deck with rank 6 or higher, or from a 60-card deck consisting of 12 cards in each of 5 different suits.

9b. Alternately or additionally to rule modification 9a, one or more wild cards are added to the deck, and a player playing a wild card chooses, either at the end of the hand immediately prior to scoring or alternately at the time the wild card is played, which card in the deck the wild card will represent. This choice is unrestricted in that any non-wild card may be chosen, or alternately this choice is limited in some manner so that only certain non-wild cards may be chosen. For example, the deck contains 2 limited wild cards that can only be used to represent a card that completes a flush or a straight for the hand in which it is played, with the choice or determination of which card the limited wild card represents being made immediately prior to scoring.

10a. Alternate Wager Rule 1. After playing the first group of cards, one or more players may pay some additional number of points to multiply a specific hand's final royalty bonus by some multiplier. For example, a player is permitted to pay 1 point in order to double the final bonus, if any, earned on his front hand.

10b. When rule modification 10a is in effect, bonuses already earned after the first group of cards is played are not eligible to be multiplied. For example, from his first group of card a player plays a pair of queens in his front hand, and then chooses to pay 1 point to double his front hand bonus. In this case, only front hand bonus amounts in excess of 7 points (the bonus for having a pair of queens in the front hand) will be doubled.

10c. Alternately or additionally to rule modifications 10a and 10b, after playing the first group of cards, one or more players may choose to wager up to some maximum number of points that they will achieve certain goals at the end of the hand, and/or may choose to wager that a specified opponent will (or will not) achieve certain goals at the end of the hand. Each such wager, if lost, is paid to a specific opponent, or if won is collected from that specific opponent. Each such optional wager may have different odds associated with it. Such wagers include but are not limited to the wagering player sweeping a specified opponent, earning any bonus, earning any front hand bonus, earning any middle hand bonus, earning any back hand bonus, getting to Fantasyland, making a Flush or better in the Back hand, making a Straight or better in the Back hand, and/or winning at least a specific number of points overall. Such wagers also include but are not limited to a specific opponent sweeping the wagering player, earning any bonus, earning any front hand bonus, earning any middle hand bonus, earning any back hand bonus, getting to Fantasyland, making a Flush or better in the Back hand, making a Straight or better in the Back hand, and/or winning at least a specific number of points from the wagering player.

11. Alternate Wager Rule 2. Before any cards are dealt, one or more players may pay some additional number of points to multiply a specific hand's final royalty bonus by some multiplier. For example, a player is permitted to pay 1 point in order to double the final bonus, if any, earned on his front hand.

11a. Before any cards are dealt, one or more players may choose to wager up to some maximum number of points that they will achieve certain goals during the upcoming hand, and/or may choose to wager that a specified opponent will (or will not) achieve certain goals at the end of the hand. Each such wager, if lost, is paid to a specific opponent, or if won is collected from that specific opponent. Each such optional wager may have different odds associated with it. Such wagers include but are not limited to the wagering player sweeping a specified opponent, earning any bonus, earning any front hand bonus, earning any middle hand bonus, earning any back hand bonus, getting to Fantasyland, staying in Fantasyland if starting there, making a Royal Flush in the Back hand, making a Straight Flush in the Back hand, and/or winning at least a specific number of points overall.

11b. Alternately or additionally to rule modification 11a, before any cards are dealt, one or more players may choose to pay a specified number of point to participate for the upcoming round in a pooled, accumulating jackpot which they will win if they play one of the specified hands. For example, one player may pay 1 point before cards are dealt in order to be entitled to win a jackpot if he plays 3 Aces in his Front hand without fouling. Each time a player does so, some fraction of the 1 point is added to the jackpot and the remainder is paid to another specified player. Alternately, each game one or more players is automatically treated as participating in such a pooled, accumulating jackpot, with some fraction of that player's wager for that game being added to the jackpot.

11c. Alternately or additionally to rules 11, 11a, and 11b, before the game begins, one of more players may choose to wager up to some maximum number of points that all cards dealt to that player during the game, taken collectively, will possess or lack certain features. Such wagers include, but are not limited to, having more red cards than black cards, having more black cards than red cards, containing 4 cards of the same rank, containing at least a specified number of pairs, containing at least a specified number of three-of-a-kinds, containing 4 cards of the same rank, containing no cards of a specified rank or ranks, containing at least a specified number of cards of a specified rank or ranks, containing at least one card of each different rank, containing no suit of 5 or more cards, containing at least 2 suits of 5 or more cards, containing at least a specified number of cards of any suit, or having no 5-card subset that makes a poker hand of at least a straight or higher.

11d. Alternately or additionally to rules 11, 11a, 11b, and 11c, before each group of cards is dealt, one of more players may choose to wager up to some maximum number of points that the cards in that next dealt group, taken collectively, will possess or lack certain features. Such wagers include, but are not limited to, having more red cards than black cards, having more black cards than red cards, having all red cards, having all black cards, having all cards of the same color, having all cards of the same suit, having all cards of consecutive rank, containing at least one pair, containing at least one three-of-a-kind, containing no cards of a specified rank or ranks, containing at least a specified number of cards of a specified rank or ranks, containing no cards of a specified suit, or containing at least a specified number of cards of a specified suit. The ranks and suits so specified are, or alternately are not, varied based on the cards the player needs to complete various poker hands in the game.

11e. Alternately or additionally to rules 11, 11a, 11b, 11c, and 11d, before the game begins, one of more players may choose to wager up to some maximum number of points that the cards in any one or more dealt groups dealt during the game, taken collectively, will possess or lack certain features. Such wagers include, but are not limited to, having more red cards than black cards, having more black cards than red cards, having all red cards, having all black cards, having all cards of the same color, having all cards of the same suit, having all cards of consecutive rank, containing at least one pair, or containing at least one three-of-a-kind.

12. Identity Coded Computer Play History Rule. Before a human player plays a particular game, he may provide his identity to a computer. This is done by allowing the human player to provide a machine-readable card that stores his identity, or with a fingerprint reader, or through some other secure means. The computer stores the identity of every player who has ever played against the computer player and the history of some or all games played by each human player against the computer.

Alternately or additionally, this history is stored on a machine-readable card that the human player keeps in his possession. If the human player successfully completes one or more specific sets of goals (also see Missions Rule below) within a specified number of consecutive games, or alternately within a limited time period, or alternately with unlimited duration and unlimited games, the human player win the number of bonus points associated with the set of goals accomplished, or alternately wins a pooled, accumulating jackpot of a type described in rules modification 11b. For example, if over the course of 50 consecutive games, the human player completes (without fouling) a front hand containing each of the 13 different pairs, (a pair of aces, kings, . . . , deuces), the player wins a bonus of 50 points. For another example, if over the course of 10 minutes, the human player completes a back hand that is a flush in each of the 4 different suits, the player wins a bonus of 10 points.

13. Solitaire Rule. The game has only one player (“human player”). During scoring, for purpose of determining whether the human player has won, lost or tied each of his hands, the human player is treated as though he played against an opponent who had certain specified hands. For example, the human player's front hand is scored as if he played against an opponent who had “AK2” in his front hand, the human player's middle hand is scored as if he played against an opponent who had “JJ432” in his middle hand, and the human player's back hand is scored as if he played against an opponent who had “43322” in his back hand.

13a. Alternately to rule modification 13, the game has only one player and that player pays a specified number of points for the right to play each game and to receive royalty bonuses based on the hands he forms, provided that he does not foul his hand. Optionally, the player also wins a specified number of points if all of his hands exceed specified minimum qualifying hands, or alternately if he completes the hand without fouling. For example, if the player makes at least AK2 in his front hand, at least JJ432 in his middle hand, and at least 43322 in his back hand, without fouling, then he wins the number of points that he originally paid to play the game. Or alternately, for example, if the player completes the hand without fouling, then he wins 50% of the number of points that he originally paid to play the game.

Conventionally, OFCP is only played as a 2-4 player game. This rule modification allows the game to be played by one player. (Not by 2 players with the computer playing for one of the players, but truly as a 1-player, solitaire game). This is accomplished (as explained in 13a) by having the player pay for the right to play the game and score/win only by creating hands that earn royalty bonuses. Alternately (as explained in 13) scoring works as in normal OFCP (where you win/lose points based on whether you win or lose against corresponding opponent hands) except that hands the player makes are scored against a predetermined set of opponent hands.

14. New Bonus Rule. Additional bonuses are won when 2 or more of a player's hands meet certain hand strength requirements at the same time. For example, the player wins 100 points for making four-of-a-kind in both of his 5-card (middle and back) hands in the same game.

This rule creates new bonuses for having 2 or more hands in the same game that meet specific criteria, for example making a flush in both of the 5-card hands wins a bonus in addition to the bonus earned for making each of the 2 flushes individually.

15. No Foul Rule. The fouling rule that requires the relative strengths of the player's hands to be in a specific order is eliminated. Regardless of the relative strength of a player's hands, his hands are eligible to win bonuses and, if the game has more than one player, each player's hands are always scored against those of each other player.

16. Trash Hand Rule. One hand (front, middle or back) for each game is designated as the trash hand. This hand scores no bonuses for any players and, if the game has more than one player, is not scored against the trash hand of other players. Alternatively, one player may pay some points to have one of his hands designated as a trash hand, whether or not the other players also do so. This player's trash hand is not scored in any way, and the player pays no points or royalties to any other player on this trash hand. Game points may be set beyond which it is too late to designate a trash hand.

17. Multiple Instances Rule. Before starting a game, a player can choose to play one or more additional instance of the upcoming game. The game is then played normally until immediately before the final group of cards is dealt to that player. That player is then dealt multiple instances of a final group of cards, each dealt at random from the cards remaining in the deck and immediately before the final group of cards is dealt to the player for the hands already in play. The player then plays each final group of cards, in instances of the cards already in play, and scores each instance of the game in the usual fashion, independent of each other instance of the game.

18. Computer Co-play Rule. The player can choose to have the computer suggest a way to play his current cards. The player can then accept the computer's suggested play or can change it to play the cards in any way he chooses. Optionally, the player can designate that certain cards be played in specific hands and have the computer suggest a way to play the remainder of the cards.

18a. Alternately or additionally to rule 18, the computer automatically plays some or all groups of the player's cards. For example, when rule 17 is in effect and a player chooses to play multiple instances of the game, the computer automatically plays each instance of the player's final set of cards.

19. Identity Coded Computer Play History-Mission Rule. The player is presented with a series of one or more active missions. Each play of the game that meets certain specified minimum bet requirements can, but does not necessarily, help the player make progress towards the accomplishment an active mission. When a player fully accomplishes an active mission, the player receives one or more specified rewards and is then presented with a new active mission.

Such missions include, but are not limited to, winning a specified total number of points, winning a specified number of points in a single game, winning any bonus for a specified number of consecutive games, playing a specified number of games, making a specified total amount of points in bets, making a specified number of straights, making a specified number of flushes, making a specified number of full houses, making a specified number of 4-of-a-kinds, making a specified number of flushes in each of the 4 different suits, making a specified number of full houses of each of the 13 different ranks, making a specified number of 4-of-a-kinds in each of the 13 different ranks, making a specified number of a specified hand such as two-pair aces and eights, making a specified number of each of a specified list of different types of hands such as making two straights and two flushes and two full houses, making a straight in 2 5-card hands in the same game a specified number of times, making a flush in 2 5-card hands in the same game a specified number of times, making a full house in 2 5-card hands in the same game a specified number of times, and having all cards dealt to that player during the game, taken collectively, possess or lack certain feature, such as possessing three-of-a-kind dealt in 3 different ranks, or possessing or lacking any of the other features listed in rule 11c.

Such rewards include, but are not limited to, winning a specified number of points, the right to play the next specified number of hands for free, receiving some multiple of the number of points won on the final game of the mission, being able to play the next specified number of games with increased bonus payouts for making certain specified hands, or more advantageous game rules such as being able to play the next specified number of games seeing all cards in all groups before playing any cards, having the next specified number of games play automatically in the manner that maximizes total points won, being dealt additional cards in the next specified number of games, receiving free side bets of the type described in rule 11a-e, unlocking the ability to play a greater number of instances of each game than was previously permitted, and unlocking the ability to make new side bets of the type described in rules 11a-e that were previously unavailable.

Generally, the reward that a player wins for completing a mission can be many things besides a simple number of bonus points. A major part of the long-term appeal of the game is to provide the player with an ever more exciting string of rewards to win as they accomplish more and harder missions.

19a. When rule 19 is in effect, the player may choose to abort an active mission at any time, or alternately may choose to abort an active mission after playing a specified minimum number of games or wagering a specified minimum number of points. When an active mission is aborted, the player receives none of the reward associated with that mission, or alternately receives a specified buyout reward that is less valuable that the reward for fully accomplishing the mission. The player is then presented with a new active mission in the same manner as if the aborted mission had been fully accomplished.

Rules 19 and 19a include not only completing a defined mission within a specified number of games or time limit, but also completing the mission within a span of games that starts with the hand that the player is assigned the mission. This allows for missions such as “make 4-of-a-kind of each of the 13 different ranks”, which the player keeps working towards indefinitely until it is completed and the reward is won, and where none of the 4-of-a-kind hands the player made prior to being assigned the mission are counted towards its completion.

Nothing disclosed herein is intended to limit the applicability of the disclosure to specific system or machine configurations; it is expected that some forms of the disclosed gaming system can be performed by humans without the aid of machines or other technology at all. The disclosure of earning bonuses for accomplishing a set of goals across a number of games or within a time period, regardless of where or how the history of prior games is stored, is intended to be broadly applicable to games other than OFCP. For example, this bonus play concept is applicable to all other forms of poker, whether or not played on machines. It (as well as other rule modification disclosed) is also intended to cover network implementations, where there is a central computer connected to a plurality of poker machines such that a player can complete his or her goal playing on more than one machine (e.g. player plays today on machine A and completes some of the goals needed to win the bonus, and then comes back to the casino the next day and plays the same game on a machine B, and completes the rest of the goals, as the central computer tracks player play based on the player's card or other identification and knows that the identified player wins the bonus). It is also contemplated that multiple players play with each other over a network connection each at their several terminals or computers or hand-held devices, with the processor executing the instructions from a central server or the like, all in accord with well-known network and client/server technology.

The foregoing rules modifications can be configured and combined in many ways, and across many different arrangements and systems of game playing technology and the disclosure is not to be limited except as claimed below. Following are several sample game rule sets, each of which is applied as a modification to the basic rules of Open Face Chinese Poker, and which are provided solely for illustration and without limiting the scope of this application to the configurations illustrated.

### Sample Modified Open Face Chinese Poker Game Rule Configurations

Rule Set #1:

The game is played with 2 players, identified as the human player and the computer player.

1. Each player is given 90 seconds to make each play. If a play is not made within the allotted time, the cards are played randomly among the player's hands.

2a. Each player is dealt an initial group of 5 cards, followed by a group of 4 cards, and then followed by another final group of 4 cards.

3b. The human player always plays first, followed by the computer player.

4a. The human player can lose a maximum of 6 points in any hand. However, the human player only receives one additional point for winning all 3 hands instead of the customary three points.

8. After being dealt the initial group of 5 cards, the human player is permitted to pay 2 points to surrender the hand.

Rule Set #2:

The game is played with 2-4 players, identified as the human player, computer player #1, and optionally computer player #2, and optionally computer player #3.

1. Each player is given 3 minutes to make each play. If a play is not made within the allotted time, the player forfeits the hand and loses 6 points to each of the computer players.

2a. Each player is dealt an initial group of 5 cards, followed by 4 additional groups of 2 cards each.

3a. Instead of players alternating turns, players take their turns simultaneously. So all players are dealt an initial 5 cards and place each card in their front, middle or back hand, without the other player(s) seeing how many or which cards were played in which hands until after all players have placed all of their initial 5 cards.

4a. The human player can lose a maximum of 10 points to each of the computer players in any one hand. However, the human player only receives two additional points for winning all 3 hands against a computer player instead of the customary three points.

8b. After being dealt the initial group of 5 cards, the human player is permitted to pay 3 points per computer player to exchange his initial 5 cards with those dealt to any one of the computer players (without knowing the identity of the cards to be received). Thereafter play continues normally.

10a. After playing the first group of cards, the human player may pay 1 point per computer player in order to double the final bonus, if any, earned on his front hand. The human player likewise may pay 1 point per computer player to double the final bonus earned on his middle hand, and 3 points per computer player to double the bonus earned on his back hand.

10b. Bonuses already earned after the initial group of 5 cards is played are not doubled.

Rule Set #3:

The game is played with 2-4 players.

5a. Each player creates 4 hands.

5b. Each player is dealt a total of 14 cards and uses them to create a 2-card front hand, a 3-card forward middle hand, a 4-card backward middle hand, and a 5-card back hand.

2a, 2b, 2c. Each player is dealt an initial group of 6 cards, of which they play 4 cards. They are then dealt 5 more groups of 2 cards each, for a total of 16 cards, and after each such deal the player adds the 2 newly dealt cards to the 2 unused cards from the previous card placement and then plays 2 of the 4 cards. After the final 2 cards are played, the 2 remaining unused cards are discarded.

9a, 9b. Cards are dealt from a 61-card deck consisting of 12 cards in each of 5 different suits plus one unrestricted wild card, the value of which may be chosen at the end of the hand immediately prior to scoring.

4b. Players receive a 3 point bonus for making a pair of 2s, 3s, 4s, 5s, 6s or 7s in the front hand, but receive no bonuses at all for the forward middle hand or the backward middle hand.

Rule Set #4:

The game is played with 2-4 players, identified as the human player, computer player #1, and optionally computer player #2, and optionally computer player #3.

2a. Each player is dealt an initial group of 5 cards, followed by a group of 4 cards, and then followed by another final group of 4 cards.

6a. When placing the initial group of 5 cards, all players play cards face down so that they remain unknown to the other players until the end of the game when the scores and payouts are calculated.

6b. At any point during the hand, the human player may pay 1 point to immediately reveal all of the cards that any one of the computer players played face down.

7. Immediately after drawing their initial group of 5 cards, the human player may pay one point per computer player to exchange one card from their initial group for a new card drawn at random from the deck.

Rules Set #5:

The game is played with 1 player (solitaire).

2a. The player is dealt an initial group of 5 cards, followed by a group of 4 cards, and then followed by another final group of 4 cards.

8. After being dealt the initial group of 5 cards, the player is permitted to surrender the hand and receive a rebate of 50% of the amount of he paid for the right to play the game as explained in rule 13a below.

11c. Before the game begins, the player may choose to wager up to some maximum number of points that all cards dealt to that player during the game, taken collectively, will possess or lack certain features.

11e. Before the game begins, the player may choose to wager up to some maximum number of points that the cards in any one or more dealt groups, taken collectively, will possess or lack certain features.

13a. The player pays a number of points for the right to play the game and to receive royalty bonuses based on the hands he forms.

14. The player receives additional bonuses for making four-of-a-kind in both of his 5-card hands in the same game, as well for making a straight flush in both 5-card hands, and for making a royal flush in both 5-card hands.

15. The fouling rule is eliminated. Regardless of the relative strengths of a player's hands, his hands are eligible to win bonuses.

16. The 3-card hand is designated as the trash hand. The player wins no bonuses based on the cards in his trash hand.

17. Before starting a game, the player can choose to play up to 25 instances of the upcoming game. For each instance, he pays the number of points in rule 13a for the right to play. The game is then played normally until immediately before the final group of cards is dealt to the player. The player is then dealt the chosen number of instances of his final group of cards, each dealt at random from the cards remaining in the deck immediately before the final group of cards is dealt. Each final group of cards is played and wins bonuses independently of the others.

18. The player can choose to have the computer suggest a way to play his current cards. The player can then accept the computer's suggested play or can change it to play the cards in any way he chooses.

18a. If the player chooses to play more than one instance of a game, as per rule 17, the computer automatically plays each instance of the player's final group of cards in a manner that maximizes the bonus won, and if more than one play wins the same bonus, then in a manner that wins the maximum bonus and makes the maximum progress towards completion of the active mission.

19. The player is presented with a series of active missions. Each play of the game that meets certain specified minimum bet requirements can, but does not necessarily, help the player make progress towards the accomplishment his one active mission. When a player fully accomplishes an active mission, the player receives one or more specified rewards and is then presented with a new active mission.

19a. The player may choose to abort the active mission after playing a specified minimum number of games or wagering a specified minimum number of points. When the active mission is aborted, the player receives none of the reward associated with that mission and the player is then presented with a new active mission in the same manner as if the aborted mission had been fully accomplished.

### Machine Logic

As noted herein, the game improvements may be played with or without aid of machines and or computers. When talking about machines and other playing devices, it is intended that all such machines and devices (for example, and without limitation, casino machines, computing devices, PDAs, Cell Phones, personal computers, specific purpose hand-held gaming devices, and the like) now known or later developed be included in the scope of this disclosure.

In addition to the improved game play rules disclosed and examples of possible sets of rules to be employed in a particular game, there are also disclosed examples of what are believed to be appropriate and novel machine logic and machine/system structures that can advantageously be employed in machine based game play.

A computing device stores several lists, each list containing between 0 and 52 card objects. Each card object represents one of the cards in a 52-card standard playing card deck. There are also lists of group card objects such as: Deck, Human-Cards-To-Play, Human-Front-Hand, Human-Middle-Hand, Human-Back-Hand, Computer-Cards-To-Play, Computer-Front-Hand, Computer-Middle-Hand, Computer-Back-Hand.

The term Human-Hands refers collectively to the 3 lists: Human-Front-Hand, Human-Middle-Hand, and Human-Back-Hand. The term Computer-Hands refers collectively to the 3 lists: Computer-Front-Hand, Computer-Middle-Hand, and Computer-Back-Hand.

At all times, the human player has a score, which initially represents how much money he has made available for wagering, and which is subsequently increased or decreased during the course of the game based on which wagers the human player chooses to make and how much he chooses to wager. There is no score for the computer player, because the computer player simply wins all amounts lost by the human player and loses all amounts that are won by the human player.

Machine game steps (example order only-different order of steps and smaller sets of steps may be employed without departing from the scope of the disclosure).

1. Receive input from the human player: How much money per point is the player wagering this game? For the remainder of this game, whenever the human player adds (or subtracts) points to his score, he adds (or subtracts) an amount of money equal to the number of points multiplied by the amount of money per point selected in this step.
2. Receive input from the human player: Which, if any, additional pre-game wagers (‘side bets” or “proposition bets”) is the human player making and for how much? Subtract from human player score the total number of points human player wagered in side bets.
3. Initialize Deck with 52 card objects each representing one of the cards in a 52-card standard playing card deck.
4. Randomly re-order Card objects in Deck (analogous to shuffling a physical deck of playing cards).
5. Remove the first 5 Card objects from Deck and add them to Human-Cards-To-Play. Display Human-Cards-To-Play on a screen (visible to the human player).
6. Remove the next 5 Card objects from Deck and add them to Computer-Cards-To-Play.
7. Receive input from the human player: Does human player choose to pay a specified number of points to surrender this game? If yes, go to step 16; otherwise continue.
8. Receive input from the human player: Does human player choose to pay a specified number of points to switch Human-Cards-To-Play with Computer-Cards-To-Play? If so, deduct points from human score, and switch Human-Cards-To-Play with Computer-Cards-To-Play, and display new Human-Cards-To-Play on a screen replacing the previous ones.
9. Receive input from the human player: For each Card object in Human-Cards-To-Play, select whether to move it to Human-Front-Hand, Human-Middle-Hand, or Human-Back-Hand, subject to a maximum of 3 Card objects in Human-Front-Hand and of 5 Card objects in each of Human-Middle-Hand and Human-Back-Hand. As each Card object is moved, remove it from Human-Cards-To-Play and add it to the chosen Hand, and display updated Human-Cards-To-Play and Human hands on a screen. After a Card object has been moved, human player may further move it between the 3 Human hands.
9a. When Human-Cards-To-Play is empty, display human input button allowing human player to confirm Card object final locations. Remain in step 9 until human clicks to confirm.
9b. Receive input from the human player: Which, if any, additional mid-game wagers (‘side bets” or “proposition bets”) is the human player making and for how much? Subtract from human player score the total number of points human player wagered in side bets.
10. Apply rules of logic and/or data from a lookup table to decide, for each Card object in Computer-Cards-To-Play, whether to move it to Computer-Front-Hand, Computer-Middle-Hand, or Computer-Back-Hand. After all Card objects are moved, display updated 3 Computer hands on a screen.
11. Remove the next 4 Card objects from Deck and add them to Human-Cards-To-Play. Display Human-Cards-To-Play on a screen.
12. Receive input from the human player: For each Card object in Human-Cards-To-Play, select whether to move it to Human-Front-Hand, Human-Middle-Hand, or Human-Back-Hand, subject to a maximum of 3 Card objects in Human-Front-Hand and of 5 Card objects in each of Human-Middle-Hand and Human-Back-Hand. As each Card object is moved, remove it from Human-Cards-To-Play and add it to the chosen Hand, and display updated Human-Cards-To-Play and Human hands on a screen. After a Card object from this Step has been moved, human player may further move it between the 3 Human hands.
12a. When Human-Cards-To-Play is empty, display human input button allowing human player to confirm Card object final locations. Remain in step 12 until human clicks to confirm.
13. Remove the next 4 Card objects from Deck and add them to Computer-Cards-To-Play.
14. Apply rules of logic and/or data from a lookup table to decide, for each Card object in Computer-Cards-To-Play, whether to move it to Computer-Front-Hand, Computer-Middle-Hand, or Computer-Back-Hand. After all Card objects are moved, display updated 3 Computer hands on a screen.
15. Repeat steps 11-14.
16. If human player chose in Step 7 to pay points to surrender this game, deduct the specified number of points from human score and go to step 18;
16a. Otherwise, if Human-Front-Hand is a higher ranking poker hand than Human-Middle-Hand, or if Human-Middle-Hand is a higher ranking poker hand than Human-Back-Hand, then treat the human player as having lost all 3 hands to the computer player;
16b. Otherwise, compare the rank of Player-Front-Hand with that of Computer-Front-Hand (and likewise with the Middle-Hands and Back-Hands) to determine how many of the 3 hands the player won (by having a higher ranking poker hand than the computer), lost, or tied.
17. Use lookup table to determine how many points the human player won (or lost) from hand comparisons in steps 16a-16b this game, based on how many hands the human player won, lost, and tied. Add (or subtract) that amount of points from human player score.
18. Based on the contents of the 3 Human-Hands and 3 Computer-Hands, determine which pre-game wagers from step 2, and mid-game wagers from step 9b, were won by the human player. Add the appropriate number of points (based on amount wagered and odds offered at time wager was placed) for each such wager won by the player to human player score.
19. Based on the contents of the 3 Human-Hands, and using a lookup table, add to human player score the amounts, if any, of royalty bonus points earned by each Human-Hand.
19a. Based on the contents of the 3 Computer-Hands, and using a lookup table, subtract from human player score the amounts, if any, of royalty bonus points earned by each Computer-Hand.
20. Display on a screen the human player score at the start of the game, the values of all amounts added to or subtracted from human player score during the game, and the current human player score. Display human input button allowing human player to confirm understanding of the scoring displayed. Remain in this step until player clicks button to confirm.
21. Go to step 1 to begin a new game.

An apparatus for OFCP machine play is disclosed. The apparatus can be a computer or other digital computing device (including a special purpose casino game machine) having at least one processor. The apparatus includes a non-transitory tangible machine-readable storage medium on which is stored a set of instructions. The storage medium can be one or more removable disks such as CD, DVD, BlueRay or USB drive or other memory card or the like, or it can be one or more installed hard drives or other integral memory storage parts of the computing device or machine.

The storage medium with its stored a set of instructions is separately disclosed.

Execution by the processor of the instructions on the storage medium or media cause the apparatus to send data configured to create graphic display of a game of Open Face Chinese Poker. The stored set of instructions includes a game rule set, and the game rule set includes well known rules for the game and also at least one rule variation for the game that is selected from the following rule variations: a time limits/forfeits rule, a simultaneous showdown rule, an asymmetric game scoring and royalty modifications rule, a face down play rule, an exchange cards rule, a surrender rule, an identity coded computer play history rule, a no foul rule, a trash hand rule, a multiple instances rule, a computer co-play rule and a solitaire rule.

The selected rule variations may be set in advance of the instructions in the storage medium being executed by the processor (i.e. pre-programmed) or selected rule variations may be programmed to be optionally selectable by the player or players at the time of play, i.e. during the machine play of the game. A combination of pre-programmed rule variations and player selectable rule variations may also be included in the game rule set.

Execution by the processor of the instructions on the storage medium or media further cause the apparatus to receive and store an input from a human player, to determine, using the game rule set and the input from the human player, a next game play, and to send data configured to create a graphic display of the determined next game play.

Systems and methods for processing such sets of instructions and for instructions to regulate and process such games and for human user input and for graphic display of game plays, including display of various card positions, are all believed to be well-known to those skilled in the art. For example see U.S. Pat. No. 8,727,852 previously cited.

Every instance of a rule named herein is further described elsewhere herein both generally throughout and particularly under the heading or label of the rule as named.

In one instance, a time limits/forfeits rule changes game play when the human player exceeds a preselected time limit for play by the apparatus causing a forfeit on the human player preselected from the following list of forfeits:
the player's cards are played randomly,
the player's cards are played according to an alternate pre-specified (pre-programmed) rule,
the player forfeits the current game and is scored as if he had fouled, and
the player is treated as if he has surrendered.

In another instance, an asymmetric game scoring and royalty modifications rule changes game play by the apparatus receiving from the human player an election of an alternate scoring and or royalty modification and thus limits or increases risk and respectively limits or increases reward for the player.

In another instance, a face down play rule changes game play by the apparatus receiving from the human player an election to play at least some cards face down until a point in the game later than the end of a current draw or until the end of the game.

In another instance, an exchange cards rule changes game play by the apparatus receiving from the human player an election to pay points after a draw to exchange one or more cards from the draw for different cards. Alternatively, the exchanged cards can be taken from the deck, or from the hand of another player, or the computer hand.

In another instance, a surrender rule changes game play by the apparatus receiving from the human player an election to pay points to surrender all cards and be out of the game without further scoring or penalties.

In another instance, an identity coded computer play history rule changes game play by causing the apparatus to store a history of hands and games played by the human player, and if the human player successfully completes a defined mission within a specified number of consecutive stored games, the human player wins bonus points associated with the mission.

In another instance, a no foul rule changes game play by causing the apparatus to suspend the conventional fouling rule of OFCP.

In another instance, a trash hand rule changes game play by the apparatus receiving from the human player an election to designate one hand as a trash hand, placing this hand out of play in game scoring.

In another instance, a multiple instances rule changes game play by causing the apparatus to deal a selectable number of multiple instances for the draw from the cards remaining in the deck.

In another instance, a computer co-play rule changes game play by causing the apparatus to create a graphical display of alternate suggested plays for selected as-yet-unplayed human player cards.

In another instance, in a multi-player game, a simultaneous showdown rule changes game play by the apparatus receiving from one human player an election to have all players place each card in respective front, middle and back hands without displaying how many or which cards were played in which hands until after all players have played all their cards for the draw, or alternatively for the entire game.

A method for a computing device to display a game of Open Face Chinese Poker for a human player or a plurality of human players is disclosed. The method includes the step of executing, by the computing device, a set of instructions stored on a non-transitory tangible machine readable storage medium that causes the computing device to send data configured to create graphic display of a game of Open Face Chinese Poker.

The stored set of instructions includes a game rule set, and the game rule set includes well known rules for the game and also at least one rule variation for the game that is selected from the following rule variations: a time limits/forfeits rule, a simultaneous showdown rule, an asymmetric game scoring and royalty modifications rule, a face down play rule, an exchange cards rule, a surrender rule, an identity coded computer play history rule, a no foul rule, a trash hand rule, a multiple instances rule, a computer co-play rule and a solitaire rule.

The selected rule variations may be set in advance of the instructions in the storage medium being executed by the processor (i.e. pre-programmed) or selected rule variations may be programmed to be optionally selectable by the player or players at the time of play, i.e. during the machine play of the game. A combination of pre-programmed rule variations and player selectable rule variations may also be included in the game rule set.

Execution by the processor of the instructions on the storage medium or media further cause the apparatus to receive and store an input from a human player, or for a succession of human players in a game, to determine, using the game rule set and the input from the human player, a next game play, and to send data configured to create a graphic display of the determined next game play.

In a variation of the method under the solitaire rule, the human player is the only player in the game, and the solitaire rule changes game play by the apparatus receiving from the human player an election to play a solitaire game and in the step of receiving and storing an input from the human player, the human player makes that election as the input.

### BRIEF DESCRIPTION OF THE DRAWINGS

FIG. 1 is a flowchart of one aspect of the disclosed game play method.

FIG. 2 is a schematic diagram of one aspect of the game play device.

FIG. 3 is a flowchart of another aspect of the disclosed game play method.

### DETAILED DESCRIPTION

### Definitions

The definitions beginning at paragraph [0214] of US Patent Application 2014/0018137 by Flaherty published Jan. 16, 2014, incorporated herein by earlier reference in this application are particularly adopted here.

When used in this disclosure the terms substantial and substantially or the like are used in the sense of ‘all’ or ‘very nearly all’ or ‘very nearly completely’. It is intended as a definite term and the only variation possible is to cover would-be infringers who seek to avoid the scope of a claim by making insubstantial variations. In other words, it is believed that one of ordinary skill in the art will know what is meant by any term in this disclosure which includes the words substantial or substantially.

Wherever used throughout the disclosure and claims, the term ‘generally’ has the meaning of ‘approximately’ or ‘closely’ or ‘within the vicinity or range of’. The term ‘generally’ as used herein is not intended as a vague or imprecise expansion on the term it is selected to modify, but rather as a clarification and potential stop gap directed at those who wish to otherwise practice the appended claims, but seek to avoid them by insignificant, or immaterial or small variations. All such insignificant, or immaterial or small variations are intended to be covered as part of the appended claims by use of the term ‘generally’.

Turning now to the drawings, the disclosed method and apparatus are described by reference to the numerals of the drawing figures wherein like numbers indicate like parts.

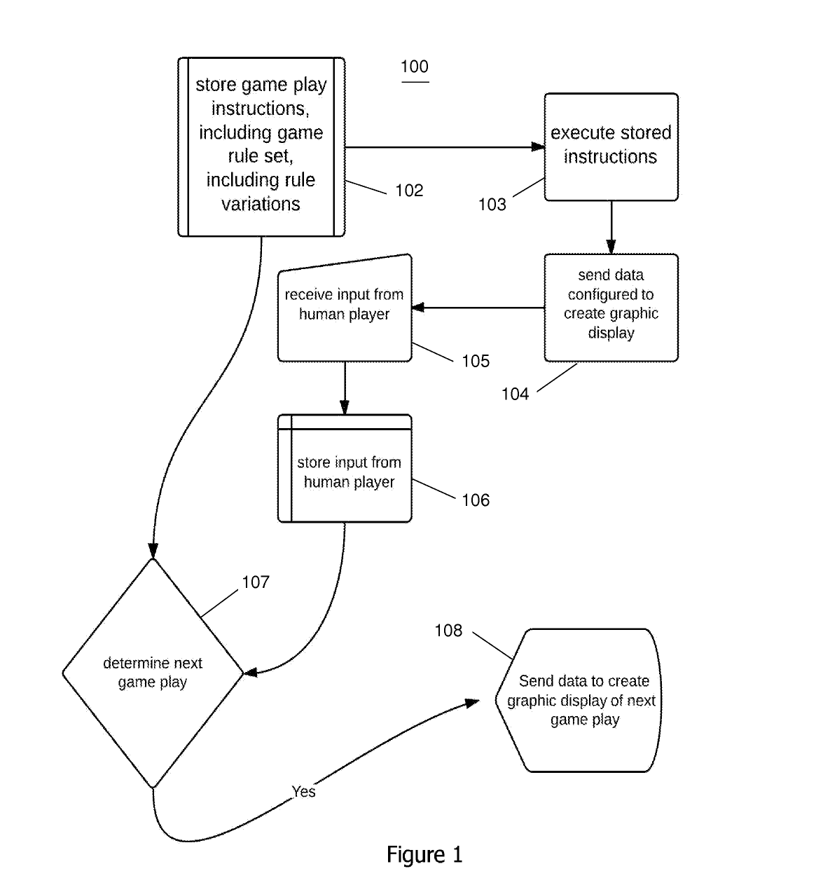

In FIG. 1, machine game play method 100 has step 102 store game play instructions, including a game rule set, which includes a set of novel rule variations, in the storage medium or media. In step 103 instructions are executed; in step 104 data are sent to a graphic display. At step 105 human input is received and stored at step 106. At step 107, the instructions from step 102 and the input from step 106 are used to determine the next game play, and at step 108 data are sent to display the next game play.

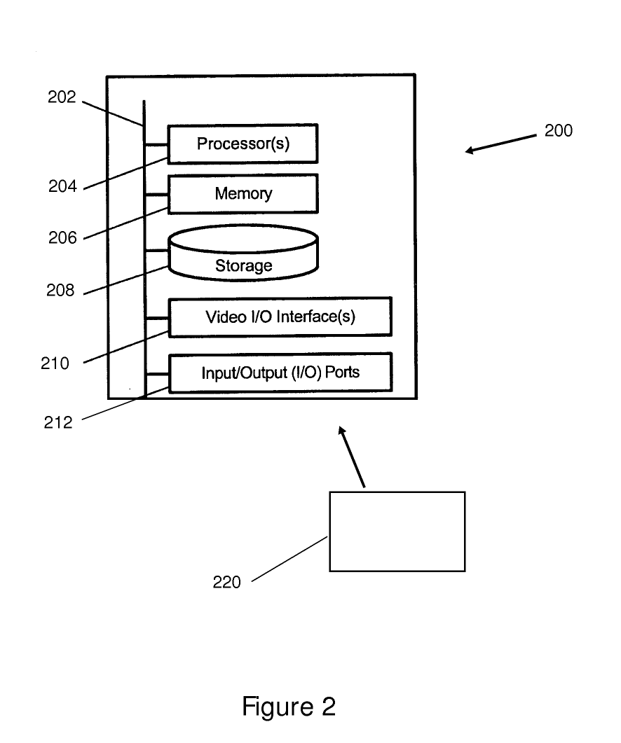

In FIG. 2, computing device or apparatus 200 has processor(s) 204, memory 206, storage 208, I/O interfaces 210, I/O ports 212 all interactively interconnected via bus 202. Tangible storage media 220 is shown by the arrow as installed or installable on apparatus 200. Schematically, storage media 220 also represents all the instructions stored on the media.

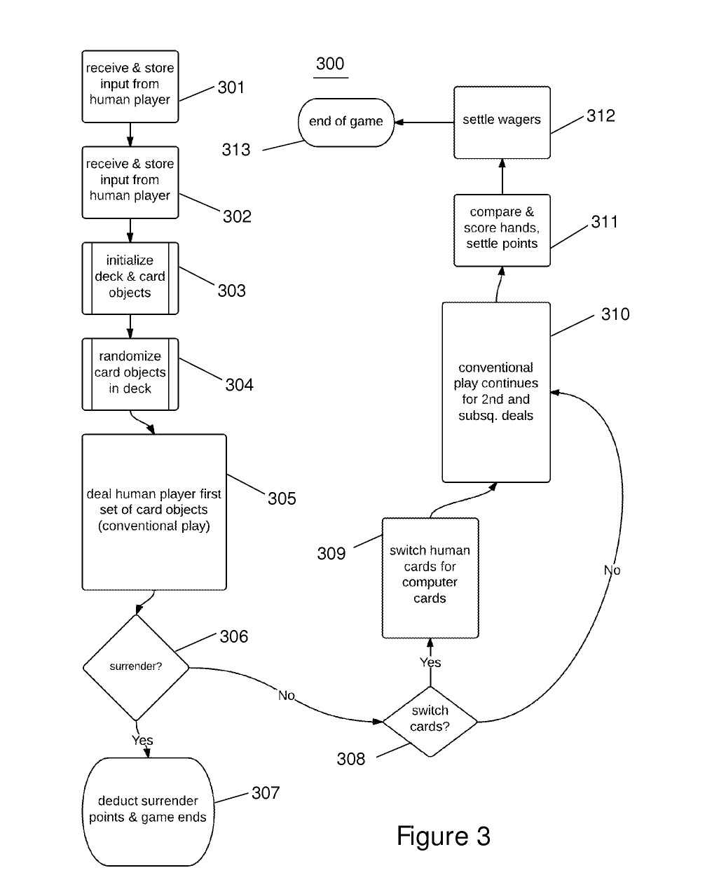

In FIG. 3, machine game play method 300 has step 301 receive and store input from human player, for example such input as how much money per point the player is wagering in this game. At step 302, further optional input is received and stored, such as which, if any, additional pre-game wagers the player wants to make. At step 303 a deck object representing a standard 52 card deck is initialized, and then ‘shuffled’ or randomized at step 304. At step 305 conventional play begins with the apparatus ‘dealing’ a first set of cards to a player.

With novel surrender rule variation in place, at step 306, the player reviews the cards just dealt and decides whether or not to surrender the game. If he decides to surrender, at step 307 he ‘pays’ the requisite number of surrender points (points are deducted from his running ‘score’, and the game ends for him (though in a multi-player game it may not end for the other players). If he does not surrender, play passes to step 308.

With novel card exchange rule variation in place, at step 308, the player reviews the cards just dealt and decides whether or not to exchange any of those cards. If he does want to exchange some or all of his cards, at step 309 he pays the requisite number of points and exchanges some or all of his cards (depending on what he paid and on the prevailing rule(s) stored in the game rule set) for new cards from the deck, or for cards from another player's hand, or from the computer hand. If he chooses to keep all cards dealt to him, play passes to step 310 conventional play (allocating dealt cards respectively to one or more of the three hands for the game, and doing so for each successive set of cards dealt) continues.

At step 311 card play has been completed for all players and the game, except for scoring, is over. At step 311, respective hands are compared and scored, and respective hand score and bonus or royalty points are allocated and respective running scores for all players are reconciled. At step 312 wagers placed before or during the game are settled and a final game score reconciliation is completed. Game ends at step 313 and a new game can begin with the same or different players at step 301.

It is to be understood that this drawing is one example of many possible game play examples, wherein two rule variations (Surrender Rule, and Exchange Rule) are shown in operation, as examples of the insertion and use of any or all of the other disclosed rule variations.

With regard to systems and components above referred to, but not otherwise specified or described in detail herein, the workings and specifications of such systems and components and the manner in which they may be made or assembled or used, both cooperatively with each other and with the other elements of the invention described herein to effect the purposes herein disclosed, are all believed to be well within the knowledge of those skilled in the art. No concerted attempt to repeat here what is generally known to the artisan has therefore been made.

In compliance with the statute, the invention has been described in language more or less specific as to structural features. It is to be understood, however, that the invention is not limited to the specific features shown, since the means and construction shown comprise preferred forms of putting the invention into effect. The invention is, therefore, claimed in any of its forms or modifications within the legitimate and valid scope of the appended claims, appropriately interpreted in accordance with the doctrine of equivalents.

We claim:

1. An apparatus comprising:
a processor;
a non-transitory tangible machine-readable storage medium on which is stored a set of instructions that when executed by the processor cause the apparatus to:
send data configured to create graphic display of a game of Open Face Chinese Poker;
wherein the stored set of instructions comprises a game rule set, the game rule set further comprising well known rules for the game with the addition of at least one rule variation selected from the group of rule variations consisting of a time limits/forfeits rule, a simultaneous showdown rule, an asymmetric game scoring and royalty modifications rule, a face down play rule, an exchange cards rule, a surrender rule, an identity coded computer play history rule, a no foul rule, a trash hand rule, a multiple instances rule, a computer co-play rule and a solitaire rule;
receive and store an input from a human player;
determine, using the game rule set and the input from the human player, a next game play;
send data configured to create a graphic display of the determined next game play.

2. The apparatus of claim 1, wherein the time limits/forfeits rule changes game play when the human player exceeds a preselected time limit for play by causing a forfeit on the human player preselected from the group of forfeits consisting of the player's cards are played randomly, the player's cards are played according to an alternate pre-specified rule, the player forfeits the current game and is scored as if he had fouled and the player is treated as if he has surrendered.

3. The apparatus of claim 1, wherein the asymmetric game scoring and royalty modifications rule changes game play by the apparatus receiving from the human player an election of an alternate scoring and or royalty modification and thus to limit or increase risk and respectively limit or increase reward for the player.

4. The apparatus of claim 1, wherein the face down play rule changes game play by the apparatus receiving from the human player an election to play at least some cards face down until a point in the game later than the end of a current draw.

5. The apparatus of claim 1, wherein the exchange cards rule changes game play by the apparatus receiving from the human player an election to pay points after a draw to exchange one or more cards from the draw for different cards.

6. The apparatus of claim 1, wherein the surrender rule changes game play by the apparatus receiving from the human player an election to pay points to surrender all cards and be out of the game.

7. The apparatus of claim 1, wherein the identity coded computer play history rule changes game play by causing the apparatus to store a history of games played by the human player, and if the human player successfully completes a defined mission within a specified number of consecutive stored games, the human player wins bonus points associated with the mission.

8. The apparatus of claim 1, wherein the no foul rule changes game play by causing the apparatus to suspend the conventional fouling rule of OFCP.

9. The apparatus of claim 1, wherein the trash hand rule changes game play by the apparatus receiving from the human player an election to designate one hand as a trash hand, placing this hand out of play in game scoring.

10. The apparatus of claim 1, wherein the multiple instances rule changes game play by causing the apparatus to deal a selectable number of multiple instances for the draw from the cards remaining in the deck.

11. The apparatus of claim 1, wherein the computer co-play rule changes game play by causing the apparatus to create a graphical display of alternate suggested plays for selected as-yet-unplayed human player cards.

12. The apparatus of claim 1, wherein the simultaneous showdown rule changes game play by the apparatus receiving from the human player an election to have all players place each card in respective front, middle and back hands without displaying how many or which cards were played in which hands until after all players have played all their cards for the draw.

13. An article of manufacture comprising:
a non-transitory tangible machine-readable storage medium;
a set of programming instructions stored in the storage medium wherein, when the programming instructions are activated by one or more processors of a host electronic device, cause the device to:
send data configured to create graphic display of a game of Open Face Chinese Poker;
wherein the stored set of instructions comprises a game rule set, the game rule set further comprising well known rules for the game with the addition of at least one rule variation selected from the group of rule variations consisting of a time limits/forfeits rule, a simultaneous showdown rule, an asymmetric game scoring and royalty modifications rule, a face down play rule, an exchange cards rule, a surrender rule, an identity coded computer play history rule, a no foul rule, a trash hand rule, a multiple instances rule, a computer co-play rule and a solitaire rule;
receive and store an input from a human player;
determine, using the game rule set and the input from the human player, a next game play;
send data configured to create a graphic display of the determined next game play.

14. A method for a computing device to display a game of Open Face Chinese Poker for a human player, the method comprising:
executing, by the computing device, a set of instructions stored on a non-transitory tangible machine readable storage medium that causes the computing device to send data configured to create graphic display of a game of Open Face Chinese Poker;
wherein the stored set of instructions comprises a game rule set, the game rule set further comprising well known rules for the game with the addition of at least one rule variation selected from the group of rule variations consisting of a time limits/forfeits rule, a simultaneous showdown rule, an asymmetric game scoring and royalty modifications rule, a face down play rule, an exchange cards rule, a surrender rule, an identity coded computer play history rule, a no foul rule, a trash hand rule, a multiple instances rule, a computer co-play rule and a solitaire rule;
receiving and storing by the computing device an input from the human player;
determining by the computing device, using the game rule set and the input from the human player, a next game play;
sending data by the computing device configured to create a graphic display of the determined next game play.

15. The method of claim 14, wherein the human player is the only player in the game, and the solitaire rule changes game play by the apparatus receiving from the human player an election to play a solitaire game and in the step of receiving and storing an input from the human player, the human player makes that election as the input.

16. The method of claim 14, wherein the at least one selected rule variation is the solitaire rule.

17. The method of claim 14 for a plurality of human players, wherein the step of receiving and storing an input from the human player is the step of receiving and storing by the computing device an input from a first human player, and wherein the steps of determining and displaying the next game play, are for determining and displaying the next game play for the first human player, and further comprising the step, after determining and displaying the next game play for the first human player, of receiving and storing by the computing device an input from a second human player, and determining by the computing device, using the game rule set and the input from the second human player, a next game play for the second human player, and sending data by the computing device configured to create a graphic display of the determined next game play for the second human player.

18. The apparatus of claim 4, wherein the human player has the option to pay points to immediately reveal at least one face down card.

19. The apparatus of claim 5, wherein the apparatus receives from the human player an election to pay points to see at least one card before the exchange.

20. The apparatus of claim 2, wherein preselected forfeit is the player's cards are played randomly.
